(19) United States
(12) Patent Application Publication
(10) Pub. No.: US 2009/0077404 A1
(43) Pub. Date: Mar. 19, 2009

(54) Method and system of reducing power consumption of system on chip based on analog-to-digital control circuitry

(75) Inventors: Alan Herring, San Jose, CA (US); Lewis Adams, Carmel, CA (US)

Correspondence Address: MURABITO, HAO & BARNES, LLP, TWO NORTH MARKET STREET, THIRD FLOOR, SAN JOSE, CA, 95113, US

(73) Assignee: Gainspan, Inc.

(21) Appl. No.: 11/901,085

(22) Filed: Sep. 14, 2007

(51) Int. Cl. G06F 1/32

(52) U.S. Cl. 713/323

(57) ABSTRACT

Methods and system of reducing power consumption of system on chip based on analog-to-digital control circuitry are disclosed. In one embodiment, a method includes converting an analog signal of external device coupled to the system on chip to a digital signal using an analog-to-digital converter (ADC) of the system on chip with a processor of the system on chip in a sleep mode or power down mode. The method further includes waking up the processor of the system on ship to perform an exception event based on a comparison of the digital signal with a threshold value associated with the external device.

### FIELD OF TECHNOLOGY

Embodiments of the present invention relate to the field of electronics. More particularly, embodiments of the present invention relate to system on chips.

### BACKGROUND

A system on chip communicates with an external device (e.g., a sensor device) to monitor the external device and/or report data obtained by the external device to a host server through a network. To monitor the external device, the system on chip may stay on continuously and/or periodically wake itself up according to a set schedule. When the system on chip is battery operated, continuous operation of the system on chip may quickly drain the local battery.

Even if the system on chip was to save some power by periodically waking itself up rather than staying on continuously, additional power may be consumed when some components of the system on chip (e.g., an analog-to-digital converter) have to stay on to process data generated by the external device. Aside from the drainage of the local battery due to the continual use of the system on chip and/or the implementation of hardware circuitry to process the data of the external device, important data (e.g., which has to be reported to the host server) may be lost if the system on chip is disabled due to the expiration of the local battery.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

An embodiment described in the detailed description is directed to a method of receiving a signal of an external device coupled to the system on chip and measuring the signal while a processor of the system on chip is in a sleep mode or power down mode. The method further includes waking up the processor of the system on chip based on a comparison of the signal with a threshold value associated with the external device.

As illustrated in the detailed description, other embodiments pertain to methods and system that reduce power consumption of the system on chip, and in particular, the reduction of power consumption in the system on chip through implementing an analog-to-digital converter (ADC) control circuit.

### BRIEF DESCRIPTION OF THE DRAWINGS

Example embodiments are illustrated by way of example and not limitation in the figures of the accompanying drawings, in which like references indicate similar elements and in which:

FIG. 1 is a network view of system on chips (SOCs) interacting with controllers and/or a number of external devices, according to one embodiment.

FIG. 2 is a schematic diagram of a SOC having an analog-to-digital converter (ADC) control circuit islanded from the rest of the SOC, according to one embodiment.

FIG. 3 is an interaction diagram of software modules of the SOC of FIG. 2, according to one embodiment.

FIG. 4 is a state diagram of the SOC of FIG. 2, according to one embodiment.

FIG. 5 is a schematic diagram of the analog-to-digital converter (ADC) control circuit of FIG. 2 used to reduce power consumption of the SOC, according to one embodiment.

FIG. 6 is a state diagram associated with the ADC control circuit of FIG. 2, according to one embodiment.

FIG. 7 is an interaction diagram of the SOC of FIG. 2 interacting with a host server through an access point, according to one embodiment.

FIG. 8 is a process flow chart of measuring the signal of an external device with a processor of a SOC in a sleep mode or power down mode, according to one embodiment.

FIG. 9 is a process flow chart of converting the signal of an external device from analog to digital data using an analog-to-digital converter (ADC) of a SOC with a processor of the SOC in a sleep mode or power down mode, according to one embodiment.

Other features of the present embodiments will be apparent from the accompanying drawings and from the detailed description that follows.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the claims. Furthermore, in the detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

Briefly stated, embodiments reduce the power consumed by a system on chip through implementing analog-to-digital converter (ADC) control circuitry. The ADC control circuitry draws a minimal power through placing a processor of the system on chip in a sleep mode or power-down mode while the signal of an external device monitored by the system on chip is within a threshold value. Additionally, more power may be saved through placing a number of components of the ADC control circuitry in a power-down mode when the components are idle.

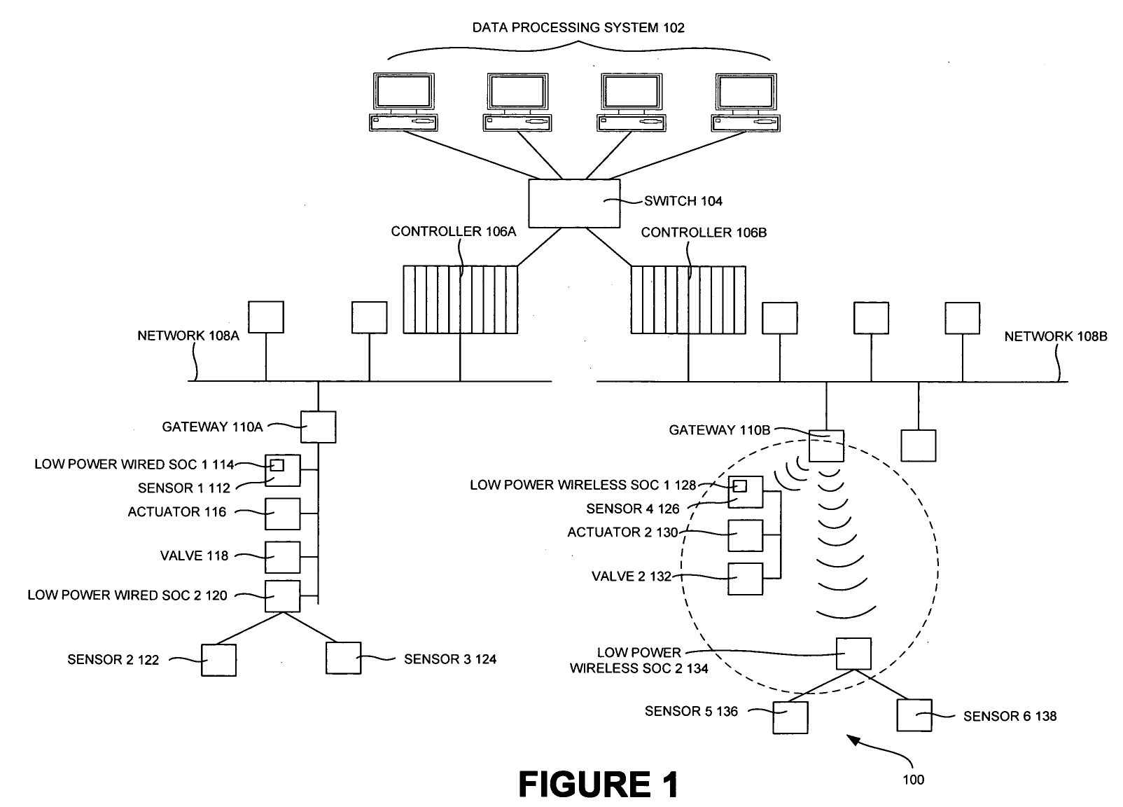

FIG. 1 is a network view of system on chips (SOCs) interacting with controllers and/or a number of external devices, according to one embodiment. Wired system on chips (SOCS) (e.g., a low power wired SOC 1 114 and/or a low power wired SOC 2 120) connect the number of external devices (e.g., a sensor 1 112, an actuator 1 116, a valve 1 118, a sensor 2 122, a sensor 3 124, etc.) to a gateway 110A. The gateway 110A is connected to a network 108A which is in turn connected to a controller 106A and/or other gateways communicating with other devices.

Additionally, Wireless system on chips (SOCs) (e.g., a low power wireless SOC 1 128 and/or a low power wireless SOC 2 134) connect the number of external devices (e.g., a sensor 4 126, an actuator 2 130, a valve 2 132, a sensor 5 136, a sensor 6 138, etc.) to a gateway 110B. The gateway 110B is connected to a network 108B which is in turn connected to a controller 106B and/or other gateways communicating with other devices. The controller 106A and/or the controller 106B may be accessed by a data processing system 102 via a switch 104.

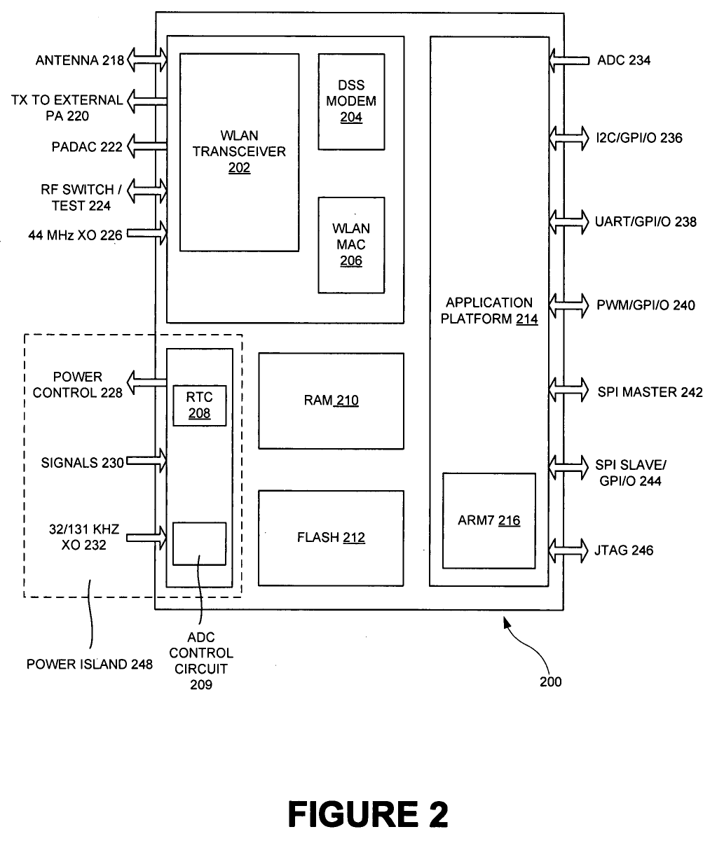

FIG. 2 is a schematic diagram of a SOC 200 having an analog-to-digital converter (ADC) control circuit 209 islanded from the rest of the SOC 200, according to one embodiment. The SOC 200 (e.g., the low power wireless SOC 1 128 and/or the low power wireless SOC 2 134, etc.) includes a processor (e.g., ARM7 216), a modem (e.g., a direct-sequence spread spectrum (DSSS) Modem 204), and a radio (e.g., a WLAN transceiver 202) in a single chip. The SOC 200 may be used by a wireless facility to monitor environmental conditions (e.g., a temperature, an occupancy, a humidity, a radiation, a vibration, a pressure, etc.).

In one example embodiment, the WLAN transceiver (e.g., a 2.4 GHz complementary metal-oxide-semiconductor (CMOS)) may have an embedded power amplifier (PA) with a programmable output power (e.g., up to 12 dBm). The PA output may be merged with low-noise amplifier (LNA) inputs. The direct-sequence spread spectrum (DSSS) modem 204 may modulate for one or more data rates (e.g., 1 Mb/s and/or 2 Mb/s).

The SOC 200 has a WLAN medium access control (MAC) 206, which provides addressing and channel access control mechanisms that make it possible for several terminals and/or network nodes to communicate with the WLAN transceiver 202. The MAC data communication protocol sub-layer of the WLAN MAC 206 may be a part of a seven-layer OSI model data link layer (layer 2). The MAC sub-layer may act as an interface between the Logical Link Control sub-layer and the network's physical layer. The MAC layer may provide an addressing mechanism called physical address or MAC address.

The SOC 200 may further include high-throughput hardware with two small private random access memories for encryption/decryption, hardware co-processing for demanding lower-MAC tasks and hardware support of IEEE 802.11i, (e.g., Counter Mode with Cipher Block Chaining Message Authentication Code Protocol (CCMP), which is a full security IEEE 802.11i encryption protocol).

An application platform (APP) 214 may be a dual processor platform which may include two ARM7 216, one to run the WLAN software and the other to run the application software, running at specified frequency (e.g., 11 MHz, 22 MHz, 44 MHz, etc.). The Arm7 216 architecture (e.g., low power consuming) may be a 32-bit reduced instruction set computer (RISC) architecture that may be widely used in a number of embedded designs. The APP 214 may be based on two separated AMBA high performance buses (AHB) to maximize the bandwidth allowed to each CPU (e.g., to avoid time-sharing when using the bus so that both CPUs are fully operational at all times). The CPUs may also be equipped with Joint Test Action Group (JTAG) test access ports 246 for hardware debug purposes.

Moreover, the SOC 200 includes a random access memory (RAM) 210 including a shared memory of 192K bytes for both CPUs and dedicated RAM of 32K bytes for the WLAN CPU. The shared RAM may be mainly used by the Arm7 216 and may contain data frames for inter-CPU communication. However, the shared RAM may also be used by the WLAN CPU during software update procedures and for future extensions of the WLAN stack if feasible. As illustrated in FIG. 2 the SOC 200 also has 384K bytes of Flash memory 212 (e.g., embedded) which may be used to update firmware. On-chip start-up code may be located in a dedicated boot ROM which may be divided for the use of each CPU.

FIG. 2 also illustrates a Real Time Clock (RTC) 208 which may provide global time and/or date to the SOC 200. The RTC 208 may contain a low-power crystal oscillator that supports a 32.768 kHz crystal and/or a 131.072 kHz crystal 232. The RTC 208 may run on a dedicated power supply, ranging between 1.2V and 3.6V. Three programmable wrap-around alarm counters may be provided to enable periodic wake-up of the SOC 200 and/or two independent external devices.

Signals 230 (e.g., external and/or analog) may wake up the SOC 200 when any of the signals exceeds its threshold value. The signals 230 may be processed by an ADC control circuit 209 which converts the signals from analog data to digital data (e.g., if needed). The ADC control circuit 209 may compare the digital data with threshold value or data (e.g., stored to registers of the SOC 200). When any one of the digital data crosses its threshold value (e.g., smaller than the low limit and/or larger than the upper limit), the ADC control circuit 209 may generate a wakeup signal to wake up the processor (e.g., the ARM7 216) of the SOC 200.

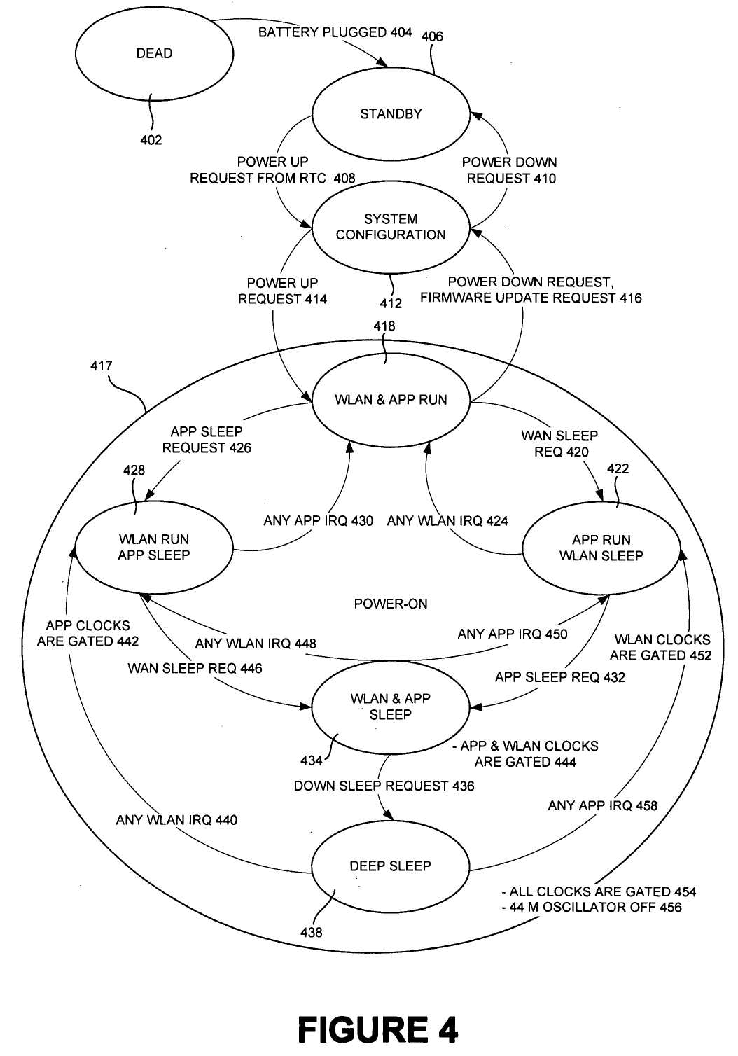

In one example embodiment, the RTC 208 and/or the ADC control circuit 209 may be isolated in a power island 248 isolated from the rest of the SOC 200. The power island 248 allows for the SOC 200 to enter an ultra-low power consumption/Standby state (e.g., a standby 406 in FIG. 4) by powering down all of the SOC 200 except the power island section. The RTC 208 and/or the ADC control circuit 209 may be the only areas of the SOC 200 receiving any power. Power to the SOC 200 may be “islanded” with the RTC 208 and the ADC control circuit 209 using thick gate techniques, which eliminate the leakage of power to other components of the SOC 200.

In an alternative embodiment, the ADC control circuit 209 may not be power islanded. In the alternative embodiment, the SOC 200 may enter the low power deep sleep state (e.g., a deep sleep 438 of FIG. 4) by gating off all of the system clocks except those used by the RTC 208 and the ADC control circuit 209. This may include stopping a 44 MHz fast crystal oscillator 226.

The SOC 200 is connected to an antenna 218 to receive and/or transmit data to and/or from an access point. Interfaces to the SOC 200 include a dedicated transmitter (Tx) output 220, a PA digital-to-analog converter (DAC) output 222, external radio frequency (RF) switches/test 224, the 44 MHz fast oscillator (XO) 226, three control outputs for power supply 228, signals 230, a 32/131 KHz slow oscillator (XO) 232, and/or ADC channels 234. The SOC 200 also supports an I²C master and slave interface 236, two multi-purpose universal asynchronous receiver/transmitter (UART) interfaces 238, up to 32 General Purpose I/Os and three pulse-width modulated (PWM) function outputs 240, external CPU interfaces via SPI master 242, a SPI slave/GPI/O interface 244 and/or a JTAG interface 246. The SOC 200 may also have power supply monitoring and/or temperature monitoring capabilities. These features may help the device be alert for over and under voltage fault conditions.

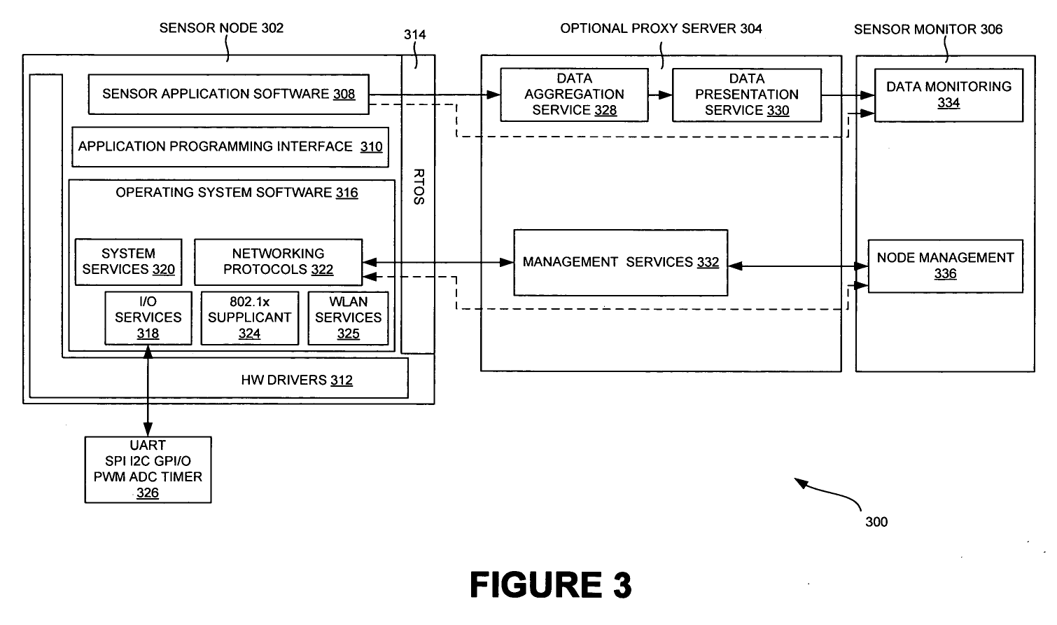

FIG. 3 is an interaction diagram of software modules of the SOC 200 of FIG. 2, according to one embodiment. A sensor node 302 may denote the location of a particular sensor (e.g., and/or other external devices) connected to the SOC 200. The sensor node 302 contains a sensor application software 308 which may be used to control the sensor (e.g., and/or other external devices) via a real-time operating system (RTOS) 314. The RTOS 314 may be a class of operating system intended for real-time applications. The RTOS 314 may operate on the hardware (HW) using hardware (HW) drivers 312. An operating system software 316 (e.g., which may act as an intermediary between the RTOS 314 and the HW drivers 312) includes system services 320, networking protocols 322, a 802.1x supplicant 324, WLAN services 325 and I/O services 318 (e.g., which interface with a UART, SPI, I2C, GPI/O, PWM, ADC, TIMER, etc. 326).

The sensor application software 308 may transmit the data to an optional proxy server 304 which may be used to manage communication of data and/or operation commands between the sensor node 302 and a sensor monitor 306. In one example embodiment, the data may be transmitted directly from the sensor application software 308 to the sensor monitor 306 (e.g., thus not requiring the service of the optional proxy server 304). In the optional proxy server 304, the data may be stacked in a data aggregation service 328 and/or may be organized and formatted in a data presentation service 330 so that it may be communicated to the sensor monitor 306. A management services module 332 in the optional proxy server 304 may be used to manage communication between the sensor node 302 and the sensor monitor 306. The data may finally be presented to the data monitoring module 334 (e.g., in the sensor monitor 306) which performs data processing/analysis based on an operator and/or a software within the data monitoring module 334 to issue commands to the sensor node 302.

FIG. 4 is a state diagram of the SOC 200 of FIG. 2, according to one embodiment. A dead state 402 may imply that no power source is connected to the system. When a battery 404 is plugged in, the real time clock (RTC) 208 is powered up and the SOC 200 makes a transition from the dead state 402 to a stand-by state 406. Power to the RTC 208 may be supplied directly from a battery (e.g., a battery plugged 404). At this state, the SOC 200 may show the lowest power consumption. The stand-by state 406 may be entered between active phases. When a power up request 408 is made by the RTC module, the SOC 200 makes a transition from the stand-by state 406 to a system configuration state 412.

To switch on the SOC 200, a DC/DC converter (e.g., regulating a voltage input to the SOC 200) needs to be on, the power isolation from the RTC 208 needs to be removed, and/or a 44 MHz oscillator needs to be switched on. In this state, only a reset of the WLAN subsystem may get released by the RTC 208. The WLAN CPU may execute required system configurations before the SOC 200 moves on to a general operation state, through another power-up request 414 to switch to a power-on state 417. The system configuration state 412 makes a transition from the power-on state 417 to the system configuration state 412 using a power-down request and/or a firmware update request 416.

Another power-down request 410 is made to make a transition from the system configuration state 412 to the stand-by state 406. The power-on state 417 is an active state where the SOC 200 is running. The power-on state 417 has various sub-states, when unused parts of the system may be programmed to be in a non-operational mode reducing power consumption. These sub-states may be combined in a sleep state, which may be generically defined as a low-power condition. The several sub-states of sleep (e.g., the APP RUN WLAN SLEEP 422, the WLAN RUN APP SLEEP 428, THE WLAN & APP SLEEP 434, and THE DEEP SLEEP 438) may result in several scenarios as can be observed in FIG. 4.

The common characteristic of the sleep states may be that both the system voltage and the system clock are available, but the clock to specific parts of the system may be gated. For instance, one of the processors might be in a wireless fidelity (Wi-Fi) mode with its clock gated, while the other processor may be running. The system is in the deep-sleep state 438 when all parts of the core system are in the sleep state and the 44 MHz oscillator may be switched off. Furthermore, the SOC 200 of FIG. 2 draws about 3 micro amps during the deep-sleep state compared to 300 milliamps drawn by the SOC 200 when the rest of the hardware module is operational.

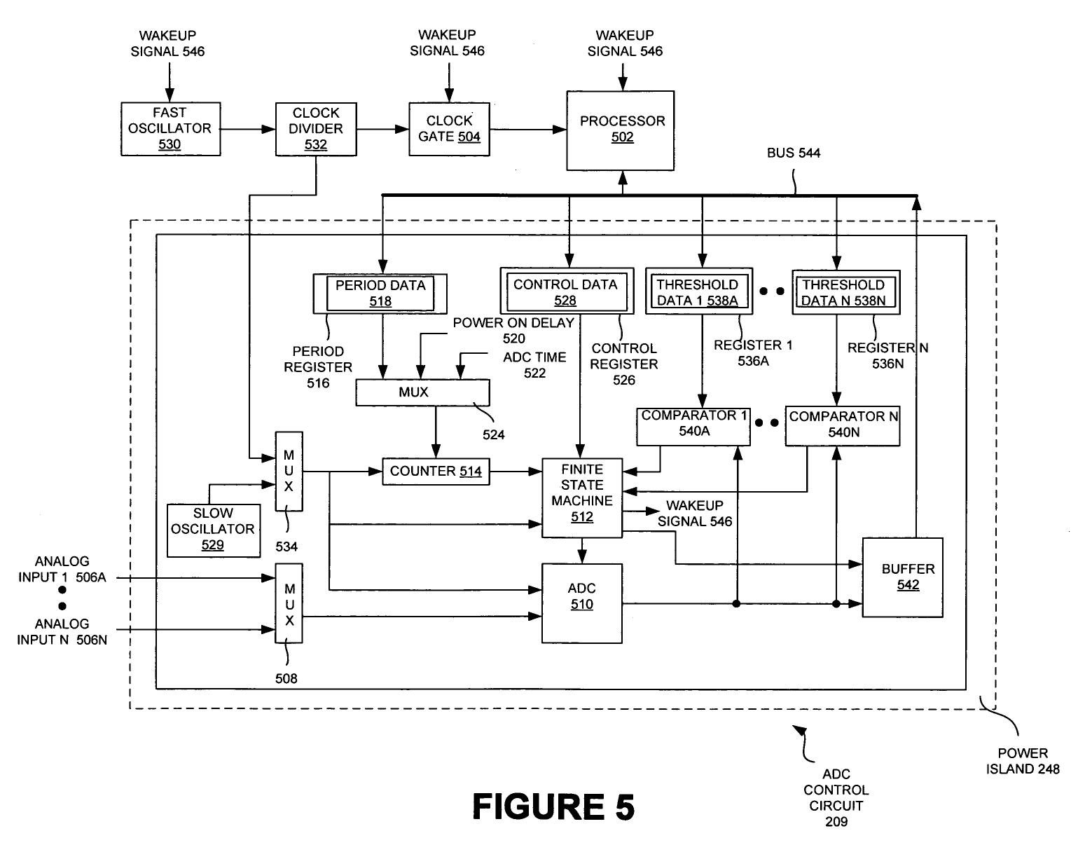

FIG. 5 is a schematic diagram of the ADC control circuit 209 of FIG. 2 used to reduce power consumption of the SOC 200, according to one embodiment. A processor (e.g., Arm7 216 of FIG. 2) 502 controlled by a clock gate 504 is in a power down mode until a wakeup signal 546 is processed. A multiplexer 508 selects one of analog inputs (e.g., an analog input 1 506A, an analog input N 506N) to guide the selected analog input to a single channel leading to an analog-to-digital converter (ADC) 510, which is controlled by a finite state machine 512.

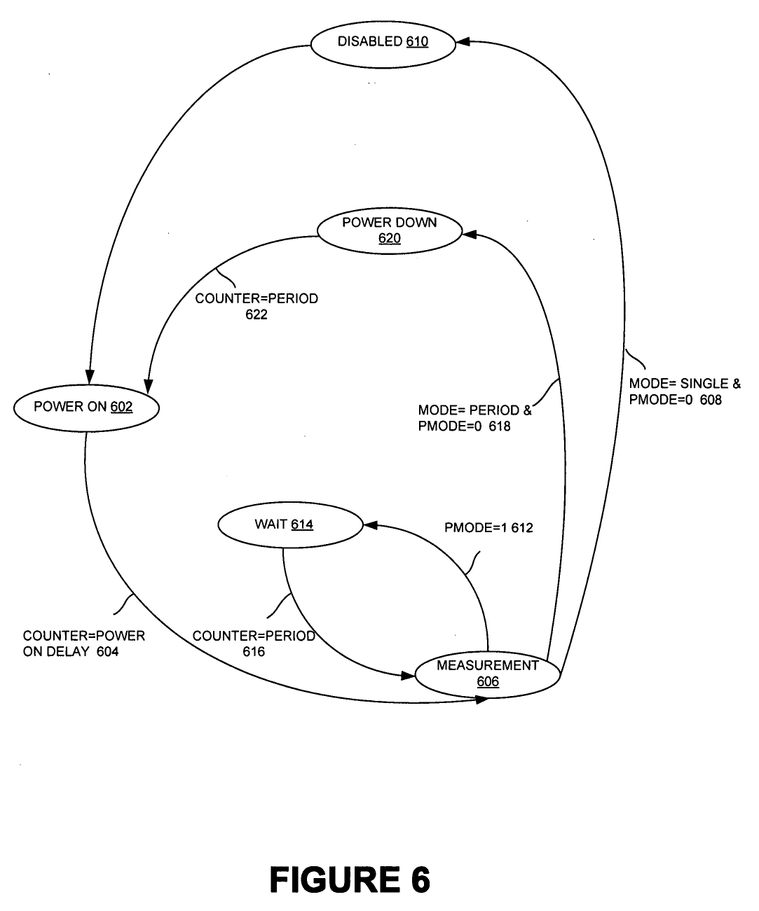

The finite state machine 512 controls a number of states, transitions between the states, and their actions associated with the ADC 510, as will be illustrated in more details in FIG. 6. The finite state machine 512 processes inputs from a counter 514 and control data 528. The counter 514 (e.g., a down counter) measures the time duration of events under the control of the finite state machine 512. A multiplexer 524 selects one among three data directed to the counter 514. A period data 518 stored in a period register 516 is an interval for sampling the analog input by the ADC 510. For period data=1000 clock cycles, the ADC 510 samples the analog input in every 1000 clock cycles.

In addition, a power on delay 520 (e.g., 15 clock cycles) may be configured to set the time it takes to ready the ADC 510 for normal operation since its inception of a power on command. An ADC time 522 (e.g., 32 clock cycles) may be configured to set the time it takes for the ADC 510 to perform the analog to digital conversion of the analog signal. The control data 528 in a control register 526 may be used to determine the mode of the ADC 510.

The control data 528 may include the type of ADC operation (e.g., a single mode, a periodic mode, etc.) and the state of the ADC 510 when the analog input is not being sampled (e.g., pmode=1 for the ADC 510 power on versus pmode=0 for the ADC 510 power down). For example, the control data 528 with “mode=period and pmode=0” indicate that the ADC 510 is to perform a periodic sampling of the analog data with the ADC 510 powered down between the sampling.

Once the analog input is sampled, it is compared with its threshold value (e.g., a threshold data 1 538A and a threshold data N 538N) stored to registers (e.g., a register 1 536A and register 536N) using a comparator (e.g., a comparator 1 540A and a comparator N 540N). For instance, the low and high threshold data for a thermometer may be set at 50 degree Farenheight and 80 degree Farenheight, respectively. Thus, any analog input below or above the range may be determined to be out of range by the comparator. When this happens, the finite state machine 512 generates a wakeup signal 546 directed to a fast oscillator 530, the clock gate 504, and/or the processor 502.

The wakeup signal 546 fed to the fast oscillator 530 (e.g., 44 MHz) may turn on the fast oscillator 530 whose clock signal (e.g., which may be divided by a clock divider 532) acts as a timer for the processor 502, the ADC 510, the finite state machine 512, and/or other components. The wakeup signal 546 fed to the clock gate 504 may disable the clock gate 504 to turn on the processor 502 along with the wakeup signal 546 fed to the processor 502.

The clock signal (e.g., which may be configured by the control data 528) from the fast oscillator 530 or a slow oscillator 529 (e.g., 32 KHz or 131 KHz) may be used to offer different clock cycles for the ADC 510, the finite state machine 512, and/or other components. For example, the use of the fast oscillator 530 as the clock source may allow faster sampling (e.g., measurement) of the analog signal, whereas the use of the slow oscillator 529 may allow less consumption of power.

When the digital input (e.g., converted from the analog input by the ADC 510) falls outside the limit of the threshold value, the digital input is stored to a buffer 542 (e.g., a first in first out (FIFO) device) to be processed by the processor 502. The processor 502 may generate an exception event upon processing the digital input accessed from the buffer 542. The exception event may include a report-out to a host server or a command to correct the state of the external device responsible for the abnormal.

Furthermore, the ADC control circuit 209 (e.g., or the ADC control system) may use a bandgap voltage or a power supply voltage as its reference voltage. The use of the power supply voltage as the reference voltage saves power which may be consumed by bandgap circuitry (e.g., which provides a power down control) had the bandgap voltage been used as the reference voltage. The power supply voltage can be also used as the reference voltage of an external device coupled to the ADC control circuit 209. On the other hand, the use of the bandgap voltage as the reference voltage provides a fixed voltage reference and higher accuracy when absolute voltage measurement is needed.

FIG. 6 is a state diagram associated with the ADC control circuit 209 of FIG. 2, according to one embodiment. As illustrated in FIG. 6, the ADC control circuit 209 is first placed on the state of power on 602. Once the counter of power on delay is counted out in transition 604, the ADC 510 of the ADC control circuit 209 in FIG. 2 converts the signal from analog to digital form in the state of measurement 606. If the mode of measurement is single measurement mode (e.g., mode=single) and the mode of the ADC 510 between the measurements is a power down mode (e.g., pmode=0) as illustrated in transition 608, the ADC 510 is powered down to the disabled state 612.

Alternatively, if the mode of the ADC 510 between the measurements is a power on mode (e.g., pmode=1) as illustrated in transition 612, the ADC 510 stays on (e.g., thus consuming power even when it is not sampling the analog signal). If the mode of measurement is periodic, it toggles between the state of measurement 606 and the state of wait 614, and the duration of the wait state 616 may be configured by the period data 518 of FIG. 5.

Additionally, if the mode of measurement is a periodic measurement mode (e.g., mode=period) and the mode of the ADC 510 between the measurements is a power off mode (e.g., pmode=0) as illustrated in transition 618, the ADC control circuit 209 is placed on the state of power down 620 (e.g., to reduce power consumption of the ADC 510). Once the counter of period (e.g., the period data 518) is counted out in transition 622, the ADC 510 is placed to the state of power on 602. Then ADC 510 stays on toggling among the state of measurement 606, the state of power down 620, and the state of power on 602.

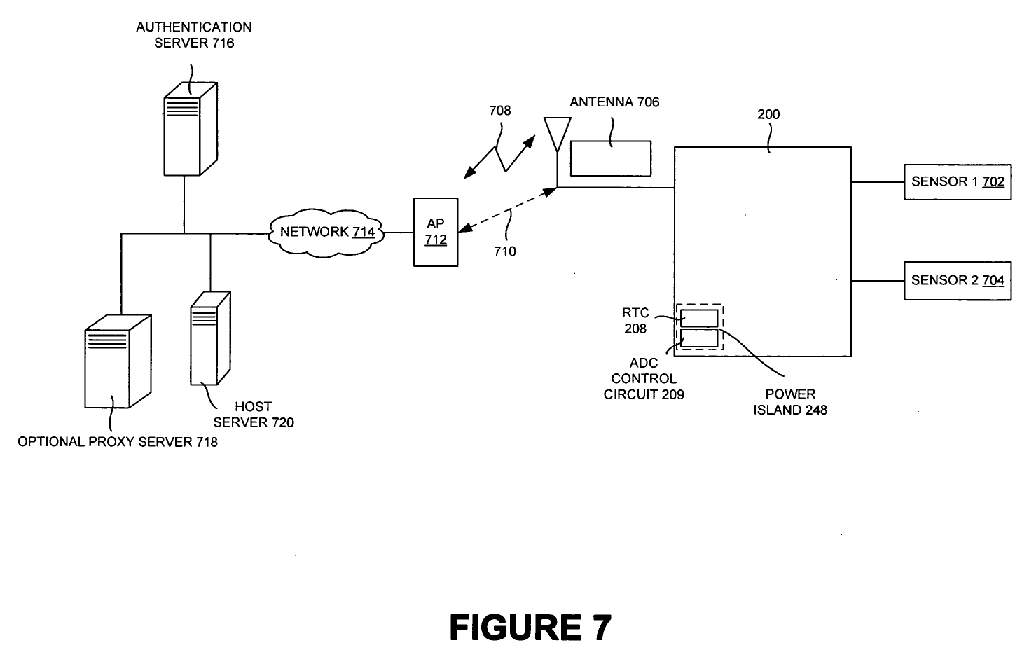

FIG. 7 is an interaction diagram of the SOC 200 of FIG. 2 interacting with a host server 720 through an access point 712, according to one embodiment. An antenna 706 may be used to receive and/or transmit data to and/or from the access point (AP) 712 (e.g., the gateway 110A and/or the gateway 110B of FIG. 1).

In one example embodiment, the SOC 200 may be connected to two sensor devices (e.g., a sensor 1 702 and a sensor 2 704). Wireless data communication 708 may take place between the sensor devices and the AP 712 via the SOC 200. Alternatively, wired data communication 710 may take place between the sensor devices and the AP 712 through the SOC 200. The AP 712 may be connected via a network 714 to an authentication server 716 (e.g., which may be used to provide authentication services to the host server 720), an optional proxy server 718, etc.

Furthermore, the sensor devices (e.g., external) may perform one or more functions (e.g., measuring temperature, pressure, humidity, vibration, etc.) and/or generate a signal (e.g., analog or digital). The SOC 200 having the RTC 208 and/or the ADC control circuit 209 may be used to minimize power consumed by the SOC 200 when communicating with external devices (e.g., the sensor 1 702, the sensor 2 704, the AP 712, etc.). In addition, the SOC 200 may communicate with the access point (AP) 712 using a radio (e.g., conforming to 802.11 a/b/g/i standard) based on a signal (e.g., which may be beyond threshold value) generated by the external devices.

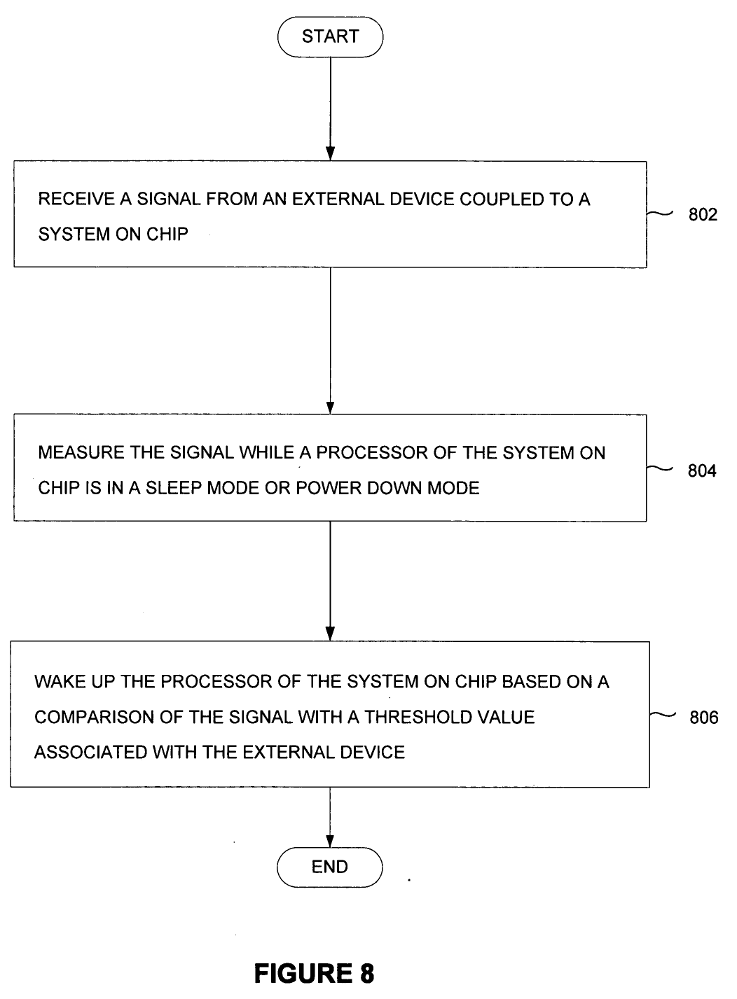

FIG. 8 is a process flow chart of measuring the signal of an external device with a processor of a SOC in a sleep mode or power down mode, according to one embodiment. In operation 802, a signal from an external device coupled to a system on chip is received. In operation 804, the signal is measured while a processor of the system on chip is in a sleep mode or power down mode. In operation 806, the processor of the system on chip is woken up based on a comparison of the signal with a threshold value associated with the external device.

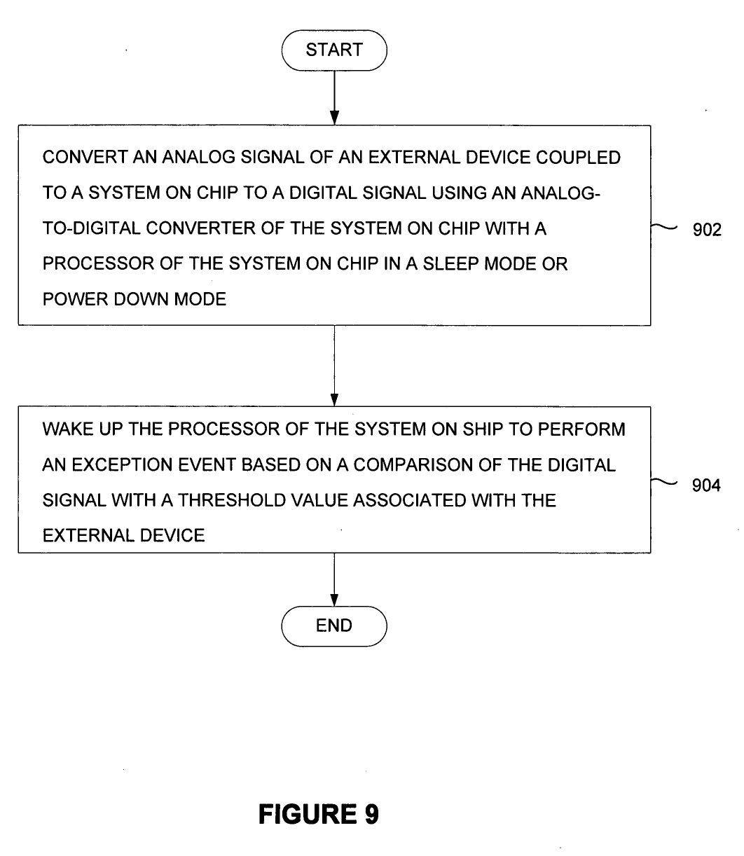

FIG. 9 is a process flow chart of converting the analog signal of an external device to a digital device using an analog-to-digital converter of a SOC with a processor of the SOC in a sleep mode or power down mode, according to one embodiment. In operation 902, an analog signal of an external device coupled to a system on chip is converted to a digital signal using an analog-to-digital converter (ADC) of the system on chip with a processor of the system on chip in a sleep mode or power down mode. In operation 904, the processor of the system on chip is woken up to perform an exception event based on a comparison of the digital signal with a threshold value associated with the external device.

In summary, embodiments described herein pertain to methods and system that reduce power consumption of system on chips, and in particular, the reduction of power consumed by the system on chip through implementing ADC control circuitry. Through minimizing power consumed by the system on chip when its processor, ADC, and/or other components is in a sleep mode or power down mode, embodiments provide more durable and/or stable system on chip which can operate independently.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for reducing power consumption of a system on chip, comprising:
receiving a signal from an external device coupled to the system on chip;
measuring the signal while a processor of the system on chip is in a sleep mode or power down mode; and
waking up the processor of the system on chip based on a comparison of the signal with a threshold value associated with the external device, wherein the threshold value is stored to a memory of the system on chip.

2. The method of claim 1, wherein the external device comprises a sensor device.

3. The method of claim 1, wherein the measuring the signal comprises converting the signal from analog data to digital data using an analog-to-digital converter (ADC).

4. The method of claim 3, wherein the comparison of the signal with the threshold value comprises periodically comparing the digital data with the threshold value.

5. The method of claim 1, wherein the waking up the processor comprises storing the signal to a buffer of the system on chip.

6. The method of claim 5, further comprising performing an exception event based on the signal to the buffer of the system on chip.

7. The method of claim 1 in a form of a machine-readable medium embodying a set of instructions that, when executed by a machine, causes the machine to perform the method of claim 1.

8. A method for reducing power consumption of a system on chip, comprising:
converting an analog signal of an external device coupled to the system on chip to a digital signal using an analog-to-digital converter (ADC) of the system on chip with a processor of the system on chip in a sleep mode or power down mode; and
waking up the processor of the system on chip to perform an exception event based on a comparison of the digital signal with a threshold value associated with the external device.

9. The method of claim 8, wherein the converting the analog signal comprises turning on power of the ADC instances before the converting the analog signal to the digital signal.

10. The method of claim 9, wherein the converting the analog signal further comprises turning off the power of the ADC after the converting the analog signal to the digital signal.

11. The method of claim 8, wherein the converting the analog signal comprises selecting a clock associated with the ADC to control a speed of the converting the analog signal to the digital signal.

12. The method of claim 8, wherein the exception event comprises at least one of reporting a status of the external device to a host server coupled to the system on chip and executing a corrective action directed to the external device.

13. A system for reducing power consumption of a system on chip, comprising:
an analog-to-digital converter (ADC) to convert an analog signal of an external device to a digital signal with a processor of the system on chip in a sleep mode or power down mode;
a comparator module to compare the digital signal to a threshold value associated with the external device; and
a finite state machine controlling the ADC to communicate a wake-up signal to the processor of the system on chip when the digital signal crosses the threshold value.

14. The system of claim 13, further comprising a buffer to store the digital signal obtained when the digital signal crosses the threshold value.

15. The system of claim 14, wherein the processor performs an exception event based on the digital signal.

16. The system of claim 13, further comprising a register to store a period of waking up the ADC.

17. The system of claim 13, wherein the ADC is controlled by the finite state machine based on control data.

18. The system of claim 17, wherein the control data comprises at least one of a single measurement mode and a periodic measurement mode of the ADC.

19. The system of claim 13, further comprising a plurality of clock oscillators to control a speed of the ADC.

20. The system of claim 13, wherein a voltage reference of the system comprises at least one of a bandgap voltage and the power supply voltage.
